(19) United States
(12) Patent Application Publication
(10) Pub. No.: US 2012/0159727 A1
(43) Pub. Date: Jun. 28, 2012

(54) Multipurpose cleaner compostion

(76) Inventors: Robert E. Hill, Richardson, TX (US); Timothy Ross, Richardson, TX (US)

(21) Appl. No.: 13/374,110

(22) Filed: Dec. 12, 2011

Related U.S. Application Data
(60) Provisional application No. 61/459,543, filed on Dec. 14, 2010.

(51) Int. Cl. A47L 13/17; C11D 3/60

(52) U.S. Cl. 15/104.93; 510/505; 510/375; 510/477; 510/463

(57) ABSTRACT

A multipurpose cleaner composition comprising a soluble silicate, a surfactant, a polyol and water is disclosed. The multipurpose cleaner composition of the present invention is generally intended for cleaning schools, offices, homes and other locations; and in particular, all types of surfaces including wood, carpet, tile, concrete and glass. In one embodiment of the present invention the soluble silicate of the multipurpose cleaner composition has a mole ratio of at least 2.5 moles of silicate per mole of alkali metal oxide. In another embodiment of the present invention the multipurpose cleaner composition will have a pH level ranging from about 10.5 to about 11.9. In another embodiment of the present invention the multipurpose cleaner composition may be further diluted by adding water to create various solutions comprising about 1 part water to 1 part multipurpose cleaner composition up to about 500 parts water to 1 part multipurpose cleaner composition.

### CROSS-REFERENCE TO RELATED APPLICATIONS

This application is related to and claims the benefit of U.S. Provisional Patent Application 61/459,543 entitled “Remedial Composition And Treatment Method” filed on Dec. 14, 2010. The provisional application is hereby incorporated in its entirety by specific reference thereto.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present invention relates to a soluble silicate based multipurpose cleaner. More specifically, the present invention relates to a multipurpose cleaner composition comprising a soluble silicate, a surfactant, a polyol, and water.

### BACKGROUND OF THE INVENTION

There is a need for multipurpose cleaning products for cleaning homes, schools, offices, businesses and factories. There is a need for multipurpose cleaning products in all types of commercial, industrial and residential settings; and in particular, cleaners for floors, bathrooms, kitchens, machinery, equipment, tanks and pipelines. It would be desirable have a multipurpose cleaner adaptable for use on all types of surfaces including wood, carpet, concrete and glass. There is also a need for providing more convenient cleaning products in the form of pre-moistened wipes or towelettes. It is also apparent that there is a need for cleaning products that are safer to use in regard to people, animals, plants and the environment. Many cleaners in the market today must be handled with care as they are toxic if ingested or caustic if spilled on skin. Still more cleaners give off harmful odors and require additional ventilation to be used safely. Accordingly, there is a significant need for cleaning products that are substantially non-toxic, non-caustic, and free of harmful odors.

Additionally, there is the issue of reduced air quality associated with the use of most multipurpose cleaning compositions in use today. Many cleaning products release volatile organic compounds (VOCs) which can be harmful to those breathing the air while cleaning or even many hours after cleaning. The United States Environmental Protection Agency (EPA) has performed a number of studies which indicate that the air in many office buildings may contain significant amounts of VOCs from various cleaning compositions used during a typical work day. The Environmental Working Group (EWG) has also measured elevated levels of VOCs in the air in schools resulting from the use of various cleaners. Moreover, the United States EPA has indicated that a contributing source of ongoing health troubles for Americans is poor indoor air quality both at work and at home. While some manufacturers attempt to reduce the VOCs in their cleaning products and new legal regulations require lower levels of VOCs, there is clearly a need for zero VOC cleaning products.

Accordingly, there is a need for multipurpose cleaning compositions that are substantially non-toxic, non-caustic and free of harmful VOCs. It is further desired to produce multipurpose cleaning compositions which are made with safer chemical ingredients and which are recognized by the United States EPA under the Design for the Environment (DIE) labeling program as providing safer chemistry in cleaning products.

### SUMMARY OF THE INVENTION

The multipurpose cleaner composition of the present invention is generally intended for cleaning homes, schools, offices, businesses and factories. A multipurpose cleaner composition is disclosed for use in all types of commercial, industrial and residential settings; and in particular, cleaners for floors, bathrooms, kitchens, machinery, equipment, tanks and pipelines. The multipurpose cleaner composition is adaptable for use on all types of surfaces including wood, carpet, concrete and glass.

In a number of exemplary embodiments of the present invention a cleaner composition comprising a soluble silicate, a surfactant, a polyol and water is disclosed. In one embodiment of the present invention the soluble silicate of the cleaner composition has a mole ratio of at least about 2.5, and preferably about 2.6 to about 4.2 moles of silicate per mole of alkali metal oxide. In another embodiment of the present invention the water of the cleaner composition further comprises from about 0.5% to about 15% dissolved oxygen (O₂). In an additional embodiment of the present invention the cleaner composition further comprises one or more of the following additives selected from sodium chloride (NaCl), potassium chloride (KCl), magnesium chloride (MgCl₂), calcium chloride (CaCl₂), hydrogen peroxide (H₂O₂), citric acid, capsicum, thymol, oil of oregano, oil of peppermint, and oil of eucalyptus.

In another embodiment of the present invention the cleaner composition will be a concentrate which may be further diluted by adding water to create useful multipurpose cleaning solutions having a ratios ranging from about 1 part water to 1 concentrate up to and including about 500 parts water to 1 part concentrate. In a further embodiment of the present invention the diluted multipurpose cleaner composition may be used in combination with a polymer non-woven or reinforced paper substrate to produce a pre-moistened wipe or towelette. These cleaning wipes may be dispensed from a container holding the wipes in small reservoir of liquid and having a top which is re-sealable to prevent evaporation or packaged in a hermetically sealed polymer pouch.

### BRIEF DESCRIPTION OF THE DRAWINGS

The present invention will be better understood in view of the detailed description in conjunction with the following figures and in which:

FIG. 1 is a graph showing percent cleaning efficiency of several cleaners compared to a 10:1 diluted multipurpose cleaner of the present invention measured in accordance with ASTM D4488-95 testing procedures; and

FIG. 2 is a graph showing percent cleaning efficiency of several cleaners compared to a modified 10:1 diluted multipurpose cleaner of the present invention measured in accordance with ASTM D4488-95 testing procedures.

### DETAILED DESCRIPTION

In its most basic form, the multipurpose cleaner is a concentrate of a soluble silicate, a surfactant, a polyol and water. These components may be combined by blending about 20 to about 80 wt % soluble silicate, about 0.1 to about 25 wt % surfactant, about 0.1 to about 25 wt % polyol, and about 0.0 to about 78.8 wt % water. Optionally, the weight percent of the water may be reduced to accommodate one or more of the following additives selected from sodium chloride (NaCl), potassium chloride (KCl), magnesium chloride (MgCl₂), calcium chloride (CaCl₂), hydrogen peroxide (H₂O₂), citric acid, capsicum, thymol, oil of oregano, oil of peppermint, and oil of eucalyptus. This concentrate composition may be further diluted with water in ratios ranging from about 1 part water to about 1 part concentrate up to and including about 500 parts water to 1 part concentrate to create a wide variety of cleaners, degreasers and other useful solutions.

The first component of the multipurpose cleaner composition is a soluble silicate. A soluble silicate is an aqueous solution containing a particular mole ratio of silicate to alkali metal oxide. The most common and most widely used soluble silicates are those of sodium or potassium, but it is believed that magnesium, calcium or lithium silicate may also be used to create a suitable multipurpose cleaner composition. For the composition of the present invention it is usually desirable to use a sodium silicate as it is highly effective and fairly economical. However, in many applications, a potassium silicate may be substituted for the sodium silicate to produce a multipurpose cleaner composition that leaves less of a visible residue upon drying and tends to reduce the potential for scratching certain sensitive or highly polished surfaces being cleaned.

Most commercially available aqueous silicate solutions have about 35% to about 40% dissolved solids content and have a preferred amount of about 38% dissolved solids content as provided by the manufacturer. Unless noted otherwise, it is understood that references herein to “soluble silicates” are to an aqueous silicate solution having about 35% to about 40% dissolved solids content. Accordingly, measured wt % values for soluble silicates will contain about 60% to about 65% water as provided by the manufacturer. Soluble silicates are commercially available in a wide range of mole ratios of silicate to alkali metal oxide, ranging from about 1:1 to about 4:1. For the present invention it is often desirable to select soluble silicates having a ratio of at least about 2.5 moles of SiO₂ per mole of Na₂O. In one preferred embodiment the soluble silicate will have a ratio of about 2.6 to about 4.2 moles of SiO₂ per mole of Na₂O. In another preferred embodiment the soluble silicate will have a ratio of about 3.1 to about 3.3 moles of SiO₂ per mole of Na₂O. In alternative embodiments using potassium silicate, the desired and preferred mole ratios would remain about the same as those indicated for sodium silicate. The soluble silicates meeting these criteria are particularly well suited for producing a cleaner composition and are available from a number of vendors in the United States including Philadelphia Quartz (PQ Corp) and Occidental Chemical (OxyChem). Alternatively, it is believed that suitable soluble silicates may be obtained from Woellner GmbH of Germany, Silmaco NV of Belgium, Shanti Chemical Works of India, YSHC (Tianjin) Chemical of China, and Qindao Silicate Factory of China.

Many commonly used soluble silicates having mole ratios of about 2:1 or less are quite alkaline in nature and have pH values greater than 12.5. These silicates would yield a composition that would be caustic to human skin. By selecting a soluble silicate having a mole ratio of at least about 2.5, and preferably about 2.6 to about 4.2 moles of SiO₂ per mole of Na₂O, it is possible to produce a multipurpose cleaner composition having a pH value of about 10.0 to about 11.9. Moreover, by using a soluble silicate with a mole ratio of about 3.1 to about 3.3 moles of SiO₂ per mole of Na₂O, it is possible to produce a composition having a pH value of about 10.5 to about 11.5. Soluble silicates that are selected for higher mole ratio (silicate:alkali metal oxide) values are not just safer to handle but also seem to provide greater long term cleaning power.

It should also be noted that raw materials to produce soluble silicates may be derived from various sources. The base materials for producing the soluble silica may be mined from the ground, produced via chemical reactions or rendered from plant matter. A few suitable sources of biogenic silica include rice, sugar cane and corn. It is known that the ash produced by burning rice hulls may produce a significant amount of soluble silica with very low levels of impurities. This is shown and described in U.S. Pat. Nos. 5,833,940 and 6,524,543, both issued to Rieber et al. In regard to manufacturing the multipurpose cleaner composition of the present invention, any soluble silica possessing the desired mole ratios and pH values may be utilized without regard to the source of the raw materials. However, it is possible that for certain applications biogenic silica may be particularly desirable either because of its relatively high chemical purity or the availability of rice hulls in many countries like India and China.

The second component of the multipurpose cleaner composition is a surfactant. One basic definition of a surfactant is an organic molecule having both a hydrophilic (water seeking) and a hydrophobic (water repelling) portion. This dual chemical nature makes surfactants particularly useful in laundry detergent and similar applications. Surfactants are commonly used to assist cleaning because the hydrophilic portion seeks out water molecules and tends to stay in solution while the hydrophobic potion seeks out dirt, grease or other solids. Much like laundry detergent, as the aqueous solution containing the surfactant is washed away, it will tend to carry the removed dirt with it. As used in the present invention, the surfactant works at the interface between solid and liquid phases to reduce the surface tension of the liquid and to thoroughly wet the medium to be treated. Such wetting results in improved contact with the active ingredients of the cleaner according to the present invention. In the cleaning compositions according to the present invention, small amounts often less than 1 wt % of surfactant is sufficient. However, up to 25 wt % of surfactant may be used to further increase interaction with soiled surfaces and produce an additional cleaning action much like soap or detergent.

Surfactants are commonly categorized by the type of ionic charge that may be carried by the hydrophilic (water seeking) portion of the molecule. The three types are anionic for a negative charge, cationic for a positive charge, and nonionic for no charge. Anionic surfactants are probably the most commonly used surfactants in commercial applications. These include linear alkyl sulfates, linear alkyl ethoxy sulfates and organo-phosphoric acid esters. Anionic surfactants like these are quite suitable for use in the multipurpose cleaner composition. By contrast, cationic surfactants may work in some applications but are generally not desired for use in the multipurpose cleaner composition. However, the preferred surfactants for use in the composition in accordance with the present invention are nonionic. These nonionic surfactants tend to derive their hydrophilic portions from polyhydroxy or polyethoxy structures in the molecule. One particularly preferred nonionic is a glucoside-based surfactant marketed as Videt Q3 available from Vitech International of Milton, Wis.

The third component of the multipurpose cleaner composition is a polyol. The term polyol may be used to refer to a number of chemical compounds including a variety of glycols, glycerins and sugars. Ethylene glycol, also referred to as automotive antifreeze, is one of the most commonly used polyols in the world. Although ethylene glycol may be used to produce a suitable multipurpose cleaner composition, it is also known to be quite toxic to humans and other mammals. The most preferred polyol for use in the multipurpose cleaner composition according to present invention would be propylene glycol, also referred to as pet-safe antifreeze. It is further believed that tri-propylene glycol (TPG), glyceryl triacetate or methyl esters of fatty acids would be non-toxic and suitable for use in the present invention. In the cleaning compositions according to the present invention, small amounts often less than 1 wt % of polyol is sufficient. However, up to 25 wt % of polyol may be used to further increase interaction with hydrocarbons and produce an additional humidicant effect keeping soiled substances moist and more workable. 100191 The forth component of the multipurpose cleaner composition is water. For most applications, this may be ordinary tap water, but it may also be desirable to use de-ionized water (DI water) in some instances. By way of example, de-ionized water may be better suited for multipurpose cleaner compositions to be used on glass or polished surfaces as it is believed to leave less residue or haze. In some instances, due to a lack of a fresh water supply, sea water may even be used to produce the cleaner composition. It is believed that the additional salts contained in the sea water will not significantly reduce the efficacy of the multipurpose cleaner composition in any way.

It may also be desirable to use water containing a small percentage of dissolved oxygen gas (O₂). The percentage of dissolved oxygen may range from about 0.5 wt % to about 15 wt %, preferably about 2 wt % to about 5 wt % for most applications, of the water component blended into the multipurpose cleaner composition. It is believed that even relatively small quantities of dissolved oxygen will serve to make the multipurpose cleaner composition faster acting. This would seem to be particularly true for degreasers or carpet spot removers where the additional oxygen radicals present in the solution are believed to assist in breaking the C—C bonds that form the backbone of large hydrocarbon molecules.

It is possible to create oxygenated water by a number of different techniques. One possible approach involves simply bubbling oxygen gas (O₂) through a container of water. Similarly, it should be possible to oxygenate the water more quickly by bubbling oxygen gas through the water as it is mechanically sheared between two closely spaced rotating surfaces. Another way of creating oxygenated water would involve the use of self-sacrificing electrodes to convert some of the H₂O into small amounts of hydrogen (H₂) and oxygen (O₂) gas. Yet another way of getting dissolved oxygen into the water would be by employing various chemical components, namely hydrogen peroxide (H₂O₂) or sodium peroxide (Na₂O₂). By incorporating a small amount, about 1 wt % to about 10 wt %, of a peroxide into the water, it would be possible to quickly and easily create an aqueous solution having the desired amount of dissolved oxygen.

The water is often the final component weighed out for blending the multipurpose cleaner composition and usually comprises the remainder of the concentrate, that is to say whatever wt % is left over after subtracting the wt % total of each of the other components from 100 wt %. It is to be understood the water will complete the multipurpose cleaner composition whether there are just three other components (soluble silicate, surfactant and polyol) or there are additional components present like citric acid, salt, thymol or other essential oils. In some instances, it may be desirable to add 0.0 wt % and rely on the combined water content of the aqueous soluble silicate, the polyol and the surfactant to produce a multipurpose cleaner composition. Of course, this is merely the amount of water added to produce the multipurpose cleaner composition in its most concentrated form. A considerable amount of water may be added later to create a wide array of cleaning and degreasing products. The multipurpose cleaner composition as a blended concentrate may be diluted in ratios ranging from about 1 part water to 1 part cleaner composition up to and including about 500 parts water to 1 part cleaner composition. It is also notable that, when fresh water is unavailable, it is possible to use sea water to dilute the multipurpose cleaner concentrate with no significant loss of efficacy.

The multipurpose cleaner composition of the present invention is also notable for having very low and usually not detectable volatile organic compound (VOC) content. In many embodiments, the multipurpose cleaner composition will exhibit no measurable VOCs. This is particularly notable because many VOCs have been categorized as carcinogens, asthmagens, neurotoxins, endocrine disruptors and so forth. A growing number of both federal and state governmental agencies have moved to restrict the VOC content allowed in many consumer and commercial products arising from various health and safety concerns. Accordingly, very low and zero VOC products are highly desirable in the new green economy. In fact, there are many cleaning applications like treating the interior of a commercial aircraft wherein the use of zero VOC products would be most desirable. A multipurpose cleaner composition comprising a soluble silicate, a surfactant, a polyol and water in accordance with the present invention qualifies as “zero VOC” according to current guidelines. In fact, the multipurpose cleaner composition of the present invention only contains trace VOC if optional components, namely certain essential oils and the like, are added. If the vapor pressure of a liquid at room temperature is less than 0.1 mm Hg, then that composition qualifies as “zero VOC”.

Design for the Environment (DIE) is a partnership initiative being put forth by the U.S. Environmental Protection Agency (EPA) to encourage the promotion of chemical products which are considered more environmentally friendly both in use and when properly disposed of. The multipurpose cleaner composition of the present invention does not contain any hazardous solvents, environmentally persistent surfactants or other harmful ingredients. The list of ingredients used to produce the multipurpose cleaner composition of the present invention has been carefully reviewed by the EPA and met the stringent requirements of DfE's standard for safer chemical-based products and qualified for the DIE Program. At this time, it is believed that the multipurpose cleaner of the present invention is quite possibly the only DIE recognized cleaning composition that is also substantially free of all VOCs.

A number of useful example compositions of the multipurpose cleaner of the present invention will now be set forth. The following compositions are intended to be merely illustrative and in no way limiting on the full range of possible multipurpose cleaner compositions as claimed herein. The diluted multipurpose cleaner examples may be prepared from a cleaner concentrate having about 55 to about 65 wt % of sodium silicate, about 0.5 to about 1.0 wt % of nonionic surfactant, about 0.5 to about 1.0 wt % propylene glycol, and about 33 to about 44 wt % water. This cleaner concentrate may then be further diluted with about 10 to about 300 parts water to 1 part concentrate to produce the diluted multipurpose cleaner compositions, as indicated.

By way of example only, it is believed that a dilution of about 10 parts water to about 1 part cleaner concentrate will produce a composition that is useful for a wide variety of household applications including removing baked on oven residue, spot treating carpet stains and cleaning grout between tiles. Most commercial and consumer oven cleaners in the market today give off noxious odors and are considered dangerous to skin and eyes. By contrast, the 10:1 diluted multipurpose cleaner of the present invention is odor free and essentially non-toxic to humans. The soluble silicate based cleaner is merely spayed onto the interior surfaces of the oven and allowed to break down baked on grease, oils and other hydrocarbons for several hours. Later, the oven may then be gently scrubbed with a non-scratch pad or a damp paper towel to remove years of grime. This same 10:1 diluted product may also be used to treat the cooking surfaces of barbeque grilling grates to remove hydrocarbon build up without fear of leaving behind a chemical residue that could be toxic to humans. Again, the diluted multipurpose cleaner is sprayed onto the cool cooking grates, allowed to rest for several hours and simply rinsed with water or wiped away.

It is also believed that the 10:1 diluted multipurpose cleaner is well suited for carpet cleaning and spot treatment of carpet stains. Many carpet cleaners contain hydrocarbon solvents that are similar to dry cleaning chemicals and other volatile organic compounds (VOCs). As noted, the 10:1 diluted multipurpose cleaner is essentially a VOC-free cleaner and is non-toxic to both humans and pets. This is particularly significant for people who may have pets with weak or weakened respiratory systems, as they can be extremely sensitive to typical carpet treatments sprayed from aerosol cans or those that otherwise put volatile organic compounds into the air. For the health and safety of people, pets and other animals, it is highly desirable to have an effective carpet cleaner that is essentially non-toxic and VOC-free. The 10:1 diluted cleaner may be sprayed onto the area to be treated, allowed to rest for several minutes and then dried with a cloth or removed with a wet/dry vacuum cleaner. More stubborn stains may be further treated with gentle brushing to work the cleaning composition into the fibers of the carpet and then blotted up with an absorbent towel.

The 10:1 diluted multipurpose cleaner is also useful for cleaning mold, mildew and other discoloration of grout between tiles. Although tile surfaces are traditionally associated with showers and other bathroom surfaces, it is becoming more common to find tiled counter tops and back splashes in kitchens and tiled floors throughout the home. Many commercial and industrial facilities now have tile floors as well. Typical grout cleaners are quite dangerous to handle and usually contain very strong acids or bases. Accordingly, most grout cleaners advise users to wear gloves to protect exposed skin and to provide additional ventilation to protect against inhalation of fumes. These strong acids or bases do indeed kill molds and mildew and commonly have a whitening effect on grout, but require considerable care in application and may actually damage the tile if allowed to remain in contact for an extended period of time. By contrast, the 10:1 diluted multipurpose cleaner of the present invention is easily sprayed onto the surface to be treated, scrubbed with a non-scratch pad, and washed away with water. No gloves are required and there is no danger of inhaling fumes. Moreover, it has been noted that the soluble silicate based cleaner seems to have a residual drying effect that tends to inhibit renewed growth of mold and mildew on the treated surfaces.

Testing was carried out using a 10:1 diluted multipurpose cleaner composition to assess long term protection from mold growth on wood products in moist environments. These tests were performed in accordance with the ASTM D3273-00 method in which a number of pine lumber blocks are placed in a controlled chamber at a temperature of 32.5±1° C. and a relative humidity of 95-98%. The test chamber is fitted with a tray filled with soil in which 3 species of mold have been allowed to sporate for 2 weeks prior to testing. The 3 species of mold used for this test were Aspergillus niger (ATCC #6275), Penicillium glabrum (ATCC #48506), and Aureobasidium pullulans (ATCC #16622). For each test run the treated pine lumber blocks were prepared in triplicate along with an untreated control block and placed in the chamber about 3 inches from the top of the inoculated soil bed.

The growth of fungus on the pine lumber blocks was monitored on a weekly basis and rated using a photographic growth scale observed at both 40× and 100× magnification in accordance with the method set forth in ASTM D3274. Growth resistance is then rated on a scale of 0 to 10 in which 0 is aggressive growth and heavy growth accumulation and 10 is the absence of any visible growth. Observations were made weekly for 4 weeks and the final growth resistance rating was assigned to each block at that time. The test results are summarized here in Table 1.

TABLE 1

| Test Group | Growth Resistance Rating | Surface Treatment |
|---|---|---|
| Control | 0.75 | None |
| 2A, 2B, 2C | 10.0 | 2 coatings |
| 3A, 3B, 3C | 10.0 | 3 coatings |
| 4A, 4B, 4C | 10.0 | 4 coatings |

Referring now to Table 1, it is notable that after 4 weeks of observation there is a dramatic difference in the untreated control blocks and the blocks treated with 2 to 4 applications of a 10:1 dilution of the multipurpose cleaner composition. The untreated control blocks had an observed growth resistance rating of 0.75 indicating very heavy growth density on a scale in which 0 would the highest possible score. In marked contrast, each one of the pine lumber samples treated with the multipurpose cleaner composition had an observed growth resistance rating of 10.0 indicating no growth of the inoculated test colonies on the test samples at any time during the 4 week test cycle. It has also been observed informally that other surfaces including tile and grout become resistant to mold growth with even a single application of the multipurpose cleaner composition. This residual effect means that bathroom tiles and the like will need to be cleaned less frequently to prevent mold and mildew than with other products on the market today.

Another example of the soluble silicate based multipurpose cleaner would be a dilution of about 30 parts water to about 1 part cleaning concentrate to create a composition suitable for all-purpose cleaning around kitchen or bathroom countertops and floors. A cleaner such as this could be used to clean up food preparation areas in the kitchen and would not leave any toxic chemicals behind. The 30:1 multipurpose cleaner would also be suitable for cleaning bathroom sinks, counter tops and vinyl laminate flooring.

One more example would be a dilution of about 60 parts water to about 1 part cleaning concentrate to create a composition suitable for use on stainless steel surfaces. This 60:1 diluted multipurpose cleaner is particularly well suited for use on stainless steel kitchen appliances and stainless steel barbeque grills. The cleaning solution is simply sprayed on to the surface to be treated and wiped clean with a paper towel or soft cloth.

In a commercial setting, a dilution ranging from about 10:1 to about 60:1 could be used to clean the exterior surfaces of vehicles which handle many forms of mass transportation. This diluted form of the multipurpose cleaner composition can be used to wash and scrub down the exterior surface of airplanes, trains and buses. Cleaner vehicles are more attractive to passengers and also reduce drag on exterior surfaces, lowering fuel costs. The diluted multipurpose cleaner would easily cut through layers of dirt, grime and oil. Hydrocarbons like motor oil, grease and fuel would be broken down or remediated into chemically stable organosilicate compounds thereby making the water runoff from the washing of these vehicles far less harmful to the environment. Safer water runoff is particularly important in that is not always easy to control the collection of the waste water in a typical commercial setting like a rail yard or an airport.

Another example would be a dilution of about 300 parts water to about 1 part cleaning concentrate to create a composition for cleaning glass or polished surfaces including wood and stone. The 300:1 diluted multipurpose cleaner is effective at removing dust, dirt, fingerprints and smudges from glass or polished surfaces without leaving any haze or residue. Moreover, the 300:1 diluted cleaner does not contribute to and actually reduces the waxy build up left behind by many furniture care products.

In another embodiment of the present invention it is also possible to incorporate the multipurpose cleaner composition in various dilutions into a pre-moistened wipe or towelette. These wipes may be produced by taking a substrate of spun nonwoven polymer or reinforced paper and wetting them with the desired multipurpose cleaner composition. These wipes are usually kept moist by storing them in a pop-up type dispenser containing a small reservoir of the cleaner composition and having a lid or cover that after repeated opening and closing forms a tight seal to keep evaporation to a minimum. Alternatively, the pre-moistened wipes may by hermetically sealed in a polymer pouch either individually or in larger quantities with a resealable flap and a mild adhesive. These multipurpose cleaning wipes would be convenient to use and completely safe to dispose of without any special handling required.

A dilution of about 10 parts water to 1 part multipurpose cleaner concentrate would be used to create pre-moistened wipes that would be ideally suited for use in the garage or workshop. As such, these wipes could also be utilized in a commercial setting for auto mechanics or car detailers. These wipes could be used to remove grease and oils from various tools making them easier and safer to handle, thereby reducing the frequency of slips and bruised knuckles. The multipurpose cleaner of the present invention would completely break down stubborn hydrocarbon residue without damaging metal or polymer surfaces. These 10:1 multipurpose cleaner wipes could also be used to safely clean wheels, chrome and other metal parts on automobiles.

A dilution of about 30 parts water to 1 part multipurpose cleaner concentrate would be used to create pre-moistened wipes that would be ideally suited for use in the kitchen or bathroom. As noted earlier, a 30:1 multipurpose cleaner composition should work well on kitchen countertops, sinks, stovetops, and food preparation areas. This 30:1 diluted composition is also useful on bathroom counters, tubs and sinks. Another use for the 30:1 multipurpose cleaner would be in pre-moistened pet wipes. These pet wipes are especially convenient for quickly wiping down a dog with muddy paws or a dirty coat before coming back into the house. The 30:1 multipurpose cleaner of the present invention is non-toxic and also reduces pet odors. The multipurpose cleaner of the present invention does not merely mask odors, in many cases it treats and eliminates the source of the odor.

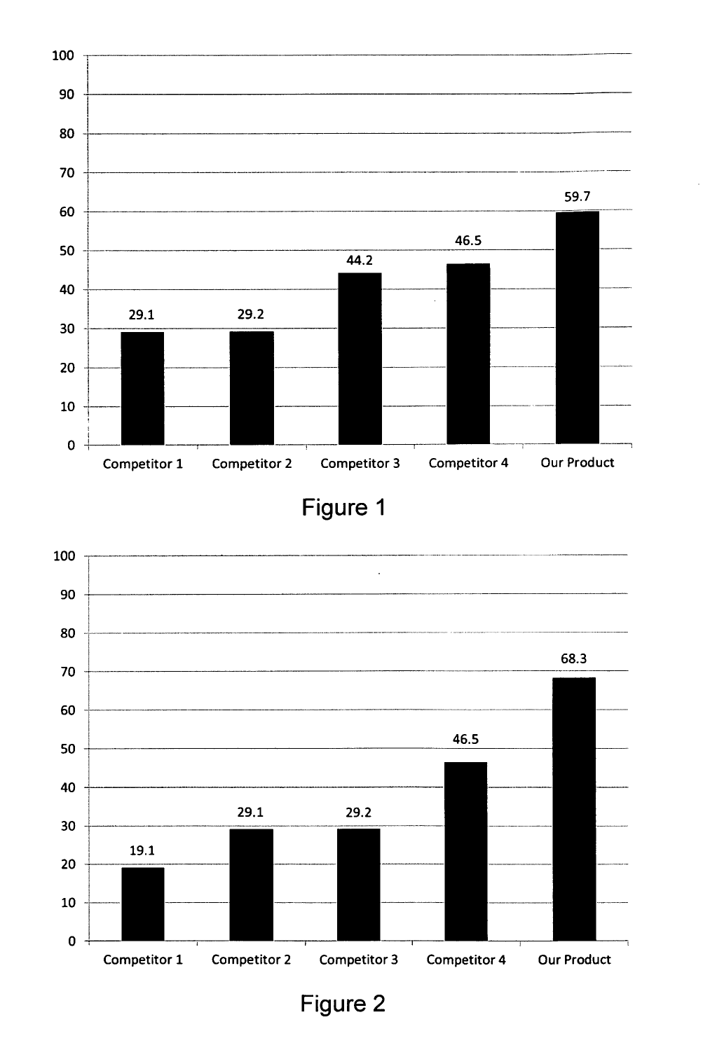

Referring now to FIGS. 1 and 2, a number of exemplary treatments performed in accordance with ASTM D4488-95 procedures were carried out using the soluble silicate based multipurpose cleaner composition of the present invention and a number of common cleaners that are readily available at this time. It is understood that these test results and graphs are provided only to better illustrate the cleaning efficiency of the multipurpose cleaner composition in of the present invention and are in no way limiting in regard to other applications that are not shown here. Specifically, ASTM D4488-95 sets forth testing procedures to measure cleaning performance of products to be used on resilient flooring and washable walls. The tests were performed according to Section A6 using a soil compound of mineral oil, carbon black and clay that is applied to white enamel painted stainless steel panels.

While not setting forth the entire testing procedure of ASTM D4488-95 in this document, it may be summarized in the following steps. Stainless steel sheeting is cut into 6 by 6 inch squares, wiped clean with acetone and painted with white satin gloss enamel. After painting, the panels should dry for 6 to 7 hours at room temperature and then for 16 to 17 hours in an oven at 54.5° C. (about 130° F.). The soil compound is produced by carefully weighing out 50 g of paint thinner, 4 g vegetable oil, 10 g mineral oil, 10 g clay and 4.5 g graphite powder. This compound is then stirred for 30 minutes to make a fairly homogeneous solution. With the test panels and soil compound at room temperature, 8 drops of soil compound are placed on each panel and wiped across the panels 10 times using a sponge applicator. The soiled panels are then dried for 30 minutes at room temperature and then for 16 to 17 hours in an oven at 54.5° C.

Testing the efficacy of a cleaning solution may then be conducted by taking a soiled panel at room temperature, wetting a clean sponge applicator with 150 ml of test solution, wiping the soiled panel 35 times and rinsing the panel under a light stream of 25° C. tap water. For each cleaning solution tested, these steps should be repeated 5 times. It is now possible to measure the percent cleaning efficiency (% CE) of each cleaning solution. In short, this is carried out by using a phototvolt reflectometer to measure the reflectance values of a clean unsoiled panel, a soiled panel and a cleaned soiled panel. Although somewhat simplified, the percent cleaning efficiency may be computed as:

% cleaning efficiency=(R_{c}−Rₛ)/(Rₒ−Rₛ)×100

where R_{c}=cleaned reflectance
Rₒ=original reflectance
Rₛ=soiled reflectance
   Accordingly, the closer the measured value of the cleaned reflectance (R_{c}) is to the measured value of the original reflectance (Rₒ), the closer the % cleaning efficiency (% CE) will be to 100%.

Referring now to FIG. 1, a number of common cleaners are tested in accordance with ASTM D4488-95 and compared to a 10:1 dilution multipurpose cleaner composition of the present invention. The multipurpose cleaner was prepared from a cleaner concentrate having about 59 wt % of sodium silicate, about 0.5 wt % of nonionic surfactant, about 0.5 wt % propylene glycol, and about 40 wt % water. This cleaner concentrate was then further diluted with about 10 parts water to 1 part concentrate to produce the 10:1 dilution multipurpose cleaner composition prior to treatment.

As shown in FIG. 1, all of the cleaners tested were at least somewhat effective at removing the prepared carbon black soil mixture from the prepared panels. The cleaners which were purchased for comparative testing resulted in cleaning efficiency values ranging from 29.1% to 46.5%. The 10:1 dilution multipurpose cleaner composition of the present invention resulted in a cleaning efficiency of 59.7%. In short, the application of the 10:1 diluted multipurpose cleaner composition removed almost 60% of the soil mixture from the prepared panels. This result was achieved without scrubbing, brushing, spraying or rewetting the surfaces to be cleaned.

Referring now to FIG. 2, a number of common cleaners are tested in accordance with ASTM D4488-95 and compared to a modified 10:1 dilution multipurpose cleaner composition of the present invention. The modified multipurpose cleaner was prepared from a cleaner concentrate having about 59 wt % of sodium silicate, about 6 wt % of nonionic surfactant, about 0.5 wt % propylene glycol, and about 34.5 wt % water. This cleaner concentrate was then further diluted with about 10 parts water to 1 part concentrate to produce the modified 10:1 dilution multipurpose cleaner composition prior to treatment.

As shown in FIG. 2, all of the cleaners tested were at least somewhat effective at removing the prepared carbon black soil mixture from the prepared panels. The cleaners which were purchased for comparative testing resulted in cleaning efficiency values ranging from 19.1% to 46.5%. The modified 10:1 dilution multipurpose cleaner composition of the present invention resulted in a cleaning efficiency of 68.3%. In short, the application of the modified 10:1 diluted multipurpose cleaner composition removed nearly 70% of the soil mixture from the prepared panels. It is believed that the additional 5.5 wt % nonionic surfactant in the multipurpose cleaner concentrate serves to achieve better wetting of the soiled surfaces to be cleaned and produces a higher cleaning efficiency. As noted earlier, this result was achieved without scrubbing, brushing, spraying or rewetting the surfaces to be cleaned.

While a number of preferred embodiments of the invention have been shown and described herein, modifications may be made by one skilled in the art without departing from the spirit and the teachings of the invention. The embodiments described herein are exemplary only, and are not intended to be limiting. Many variations, combinations, and modifications of the invention disclosed herein are possible and are within the scope of the invention. Accordingly, the scope of protection is not limited by the description set out above, but is defined by the claims which follow, that scope including all equivalents of the subject matter of the claims.

What we claim as our invention is:

1. A multipurpose cleaner composition comprising:
from about 20 to about 80 wt % of a soluble silicate;
from about 0.1 to about 25 wt % of a surfactant;
from about 0.1 to about 25 wt % of a polyol;
from about 0.0 to about 78.8 wt % water; and
wherein said soluble silicate has a mole ratio of at least about 2.5 moles of silicate per mole of alkali metal oxide.

2. The multipurpose cleaner composition according to claim 1, wherein said soluble silicate has a mole ratio of about 2.6 to about 4.2 moles of silicate per mole of alkali metal oxide.

3. The multipurpose cleaner composition according to claim 1, wherein said soluble silicate is sodium silicate.

4. The multipurpose cleaner composition according to claim 1, wherein said soluble silicate is potassium silicate.

5. The multipurpose cleaner composition according to claim 1, wherein said surfactant is a nonionic surfactant.

6. The multipurpose cleaner composition according to claim 1, wherein said polyol is propylene glycol.

7. A multipurpose cleaner composition comprising:
from about 20 to about 80 wt % of a soluble silicate;
from about 0.1 to about 25 wt % of a surfactant;
from about 0.1 to about 25 wt % of a polyol;
from about 0.0 to about 78.8 wt % water; and
wherein said composition has a pH value ranging between 10.5 and 11.5.

8. A multipurpose cleaner composition comprising:
from about 20 to about 80 wt % of a soluble silicate;
from about 0.1 to about 25 wt % of a surfactant;
from about 0.1 to about 25 wt % of a polyol;
from about 0.0 to about 78.8 wt % water; and
wherein said water further comprises from about 2 to about 5 wt % dissolved oxygen.

9. A multipurpose cleaner composition comprising:
from about 55 to about 65 wt % of a soluble silicate;
from about 0.5 to about 1.0 wt % of a surfactant;
from about 0.5 to about 1.0 wt % of a polyol;
from about 33 to about 44 wt % water; and
wherein said soluble silicate has a mole ratio of about 3.1 to about 3.3 moles of silicate per mole of alkali metal oxide.

10. The multipurpose cleaner composition according to claim 9, further comprising one or more of the following additives selected from sodium chloride (NaCl), potassium chloride (KCl), magnesium chloride (MgCl₂), calcium chloride (CaCl₂), hydrogen peroxide (H₂O₂), citric acid, capsicum, thymol, oil of oregano, oil of peppermint, and oil of eucalyptus.

11. The multipurpose cleaner composition according to claim 9, wherein said soluble silicate is sodium silicate.

12. The multipurpose cleaner composition according to claim 9, wherein said soluble silicate is potassium silicate.

13. The multipurpose cleaner composition according to claim 9, wherein said surfactant is a nonionic surfactant.

14. The multipurpose cleaner composition according to claim 9, wherein said polyol is propylene glycol.

15. The multipurpose cleaner composition according to claim 11, wherein said soluble silicate is derived from biogenic silica.

16. The multipurpose cleaner composition according to claim 9, wherein said composition has a liquid vapor pressure of less than 0.1 mm Hg at room temperature.

17. The multipurpose cleaner composition according to claim 9, wherein said composition is further diluted with water at ratios ranging from about 1:1 to about 500:1 to produce a variety of useful solutions.

18. The multipurpose cleaner composition according to claim 17, wherein said composition is used in combination with a woven or non-woven substrate to create a pre-moistened wipe.

19. The multipurpose cleaner composition according to claim 17, wherein said composition is substantially free of perfumes and masking agents.

20. The multipurpose cleaner composition according to claim 16, wherein said composition is a Design for the Environment recognized product.
